(19) United States
(12) Patent Application Publication
(10) Pub. No.: US 2016/0069107 A1
(43) Pub. Date: Mar. 10, 2016

(54) Door system and opening control

(71) Applicants: Alan K. Uyeda, Irvine, CA (US); Michael Wayne Phillips, Upland, CA (US)

(72) Inventors: Alan K. Uyeda, Irvine, CA (US); Michael Wayne Phillips, Upland, CA (US)

(73) Assignee: Syntégra LLC

(21) Appl. No.: 14/121,462

(22) Filed: Sep. 8, 2014

(51) Int. Cl. E05C 1/16; E06B 5/16; E05B 65/10; E06B 7/20

(52) U.S. Cl. CPC E05C 1/16; E06B 7/20; E06B 5/164; E05B 65/1046

(57) ABSTRACT

In a lockable door system, the combination comprising a door locking first assembly installable in a door for control of operable use to lock or unlock the door, an upper assembly including a locking plunger, and to guide plunger travel upwardly at door top level into locking and unlocking position, an actuator assembly including a rotor rotatable by handle or push bar to control door locking and unlocking, and connecting the rotor with the plunger, and door edge sealing structure.

This application is a continuation-in-part of pending U.S. application Ser. No. 13/987,952, filed Sep. 17, 2013.

### BACKGROUND OF THE INVENTION

This invention relates generally to apparatus enabling reliable in and out use of a door, with enhanced security and safety.

There is continuing need for safety and security at doorways, and for compact door latching installations contributing to security. There is also need for apparatus having unusual advantage in construction, in operation, and providing improved results, as embodied in the present invention, as will be seen.

### SUMMARY OF THE INVENTION

It is a major object of the invention to provide improvements in door opening and closing controls, enhancing in and out security at doorways; and to provide improvements in sealing of door edges with doorway frames, and at the meeting edges of pairs of doors.

Basically, door locking and unlocking apparatus embodying the invention includes:

a) a lock actuator assembly sized to fit within a door, and operatively connected to a latch at a door upper edge, with the option of adding a locking bolt at the door lower edge,

b) a push bar carried by the door at the door inside and operatively connected to the lock actuator assembly to control unlatching of the latch,

c) a handle carried by the door at the door outer side, and operatively connected to the lock actuator assembly, to control unlatching of the door only after positioning of a key to effect unblocking of the actuator assembly, with the option of having the lever or handle always active.

A further object is provision of the actuator assembly to include a first part bodily movable in response to push bar displacement to transmit actuation to a vertically movable latch actuator. As will be seen, the actuator assembly typically includes a rotor operatively connected to the handle and to said first part. The rotor is rotatable to transmit actuation to the latch actuator(s), in response to displacement of said handle, there being means blocking rotor rotation until key turning to unblock the blocking means.

An added object is to provide a clutch, internal to the actuator assembly operatively connected with the rotor to initially resist rotor rotation by the handle and subsequently to allow handle rotation after predetermined torque application as from the door handle at the outer side of the door, thereby allowing handle rotation, once the predetermined torque has been exceeded, not allowing the lock mechanism to open, and protecting the lock mechanism from damage. In this regard an assembly is provided wherein said assembly includes a lock bar movable between door locking and unlocking positions, and first and second push bars respectively to operate from door inside and outside handle positioning to control said lock bar movement. The lock bar typically has two pivoted sections respectively operable by said first and second push bars. Further, a slidable coupler is received in an opening formed by said lock bar sections, one opening in one section sized to block coupler movement relative to said one lock bar section whereby the door remains latched, and a second of said openings in the other lock bar section sized to allow coupler movement relative to said second lock bar section, whereby the door becomes unlatched. One lock bar section is movable in response to door handle movement at the outer side of the door and with associated movement of a first push bar, when the door is key unlocked, and the other lock bar section is movable in response to door handle movement at the inner side of the door, and with associated movement of a second push bar, when the door is or is not key locked.

Yet another object is to provide a door having an interior space opening only toward a vertical edge of the door, the actuator assembly received in and concealed in that space, the door being free of latching at said door vertical i.e. side edge.

Further objects concern provision of movable door edge structure, which is adjustable to seal off against the door frame in closed position of the door, as at vertically spaced locations along the door vertical edge.

These and other objects and advantages of the invention, as well as the details of an illustrative embodiment, will be more fully understood from the following specification and drawings, in which:

### DRAWING DESCRIPTION

FIG. 1 is a front elevation showing a lockable door system, and frame;

FIGS. 1a and 1b show door latching control units, in a door;

FIG. 2 is a section taken on lines 2-2 of FIG. 1;

FIG. 3 is an enlarged elevation showing construction of a latching control unit, in closed door latching position;

FIG. 4 is a view like FIG. 3, showing the FIG. 3 unit in door unlatched position;

FIG. 5 is a horizontal section taken through a closed door and showing sealing elements;

FIG. 6 is an enlarged view taken on lines 6-6 of FIG. 5; and FIG. 6a shows two opposed edges of two movable doors;

FIG. 7 is an enlarged view taken on lines 7-7 of FIG. 5;

FIGS. 8 and 9 are sections showing door structure, and in relation to hinging and frame structure;

FIG. 10 is a view showing roller assisted latching at the upper edge of the door;

FIG. 11 is a view like FIGS. 3 and 4, but showing elements in greater details;

FIG. 12 is a fragmentary elevation as in FIG. 11, showing operation;

FIG. 13 is a view like FIG. 12, showing further operation;

FIGS. 14 and 15 are views like FIG. 13, showing yet further operation;

FIGS. 16-18 are side elevations showing push bar operation, in relation to key locking and unlocking;

FIG. 19 show a push bar operating link;

FIG. 20 shows sections of a push bar; and

FIG. 21 is a perspective view of slider, as also seen in FIGS. 14 and 15.

### DETAILED DESCRIPTION

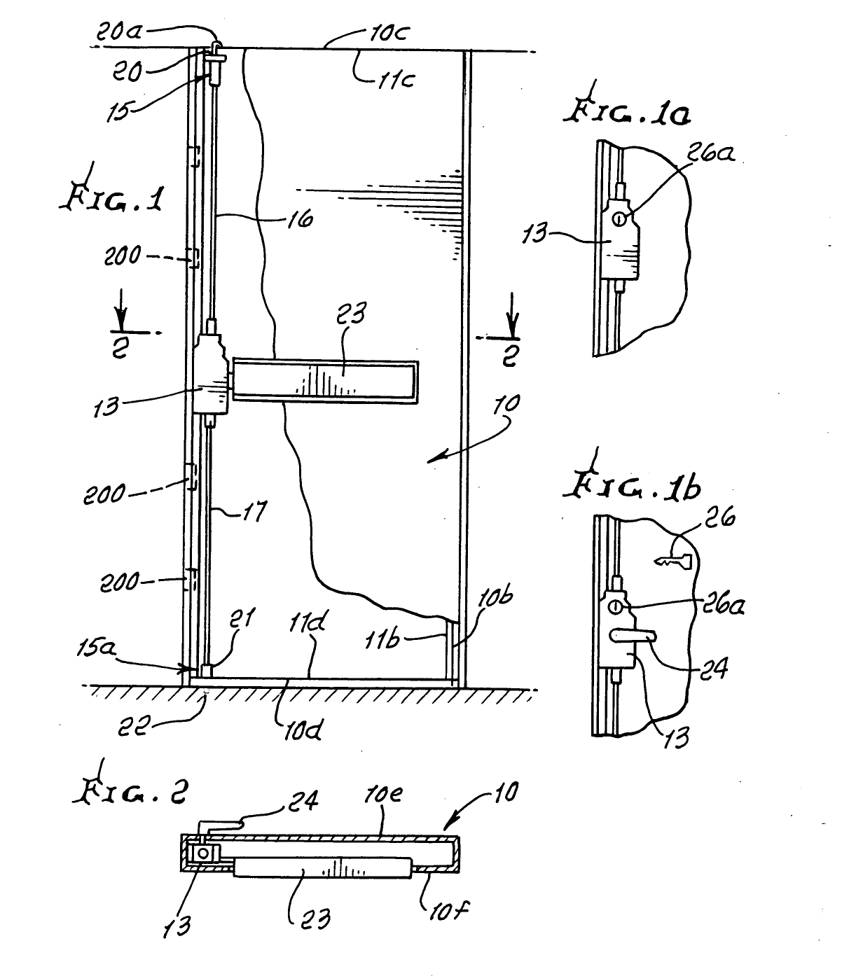

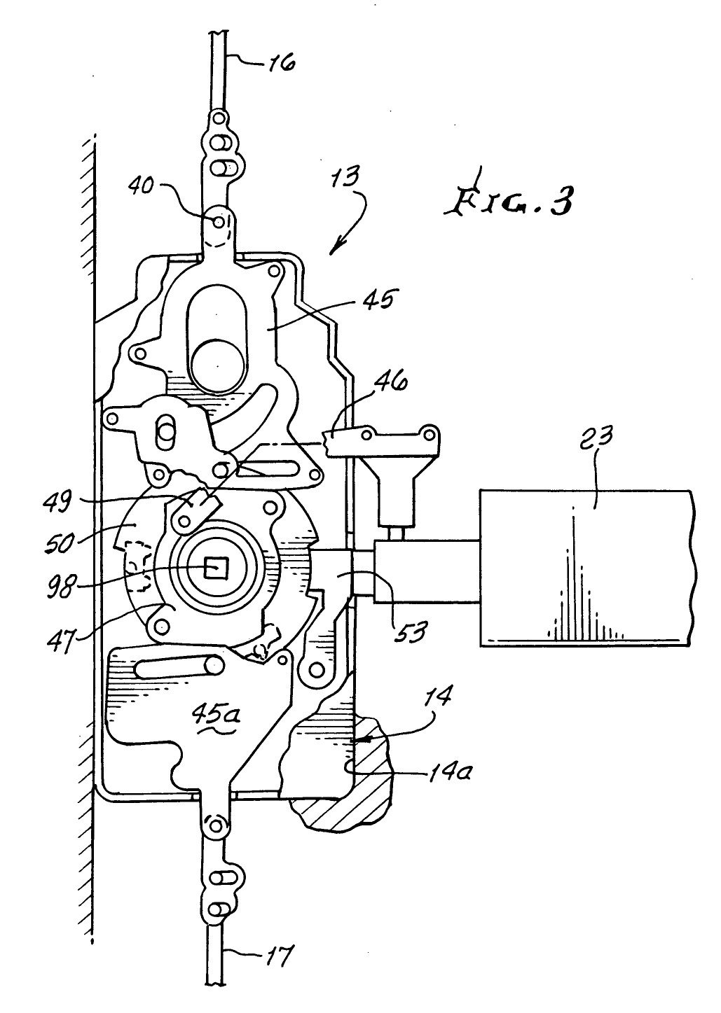

In FIG. 1, a door 10 is shown in closed position relative to a door frame 11 having upright edges at 11a and 11b, and upper and lower horizontal edges 11c and 11d. The door has corresponding edges at 10a - - - 10d. A locking control apparatus 13 is located inside the door adjacent door edge 10a, and between door panels 10e and 10f.

Latching structures 15 and 15a are located at the top and optionally at the bottom of the door, there being no latching at the door vertical edge 10a, for security. Latching control rods 16 and 17 extend vertically inside the door, from apparatus 13 to the latching structures, whereby latch 20 on rod 16 is movable into and out of latching relation with receptacle 20a on the doorway upper frame, and latch 21 on rod 17 is simultaneously movable into and out of latching relation with receptacle 22 in the doorway lower frame.

The latch rods are simultaneously movable toward the control unit 13 to unlatch the door, in response to manual pushing of a push bar 23 carried by the door at the inner side of the door; and also in response to turning of a handle 24 carried by the door at the outer side of the door, when handle rotation is unblocked by blocking mechanism within the control apparatus 13, such handle blocking and unblocking being controlled by a key 26 inserted into the door at 26a, and rotated, from the outer side of the door. Accordingly, intrusion through the doorway, from the exterior, is key controlled or configured to have an always active lever; whereas escape through the doorway, from the interior, is always available, as by pushing of the push bar.

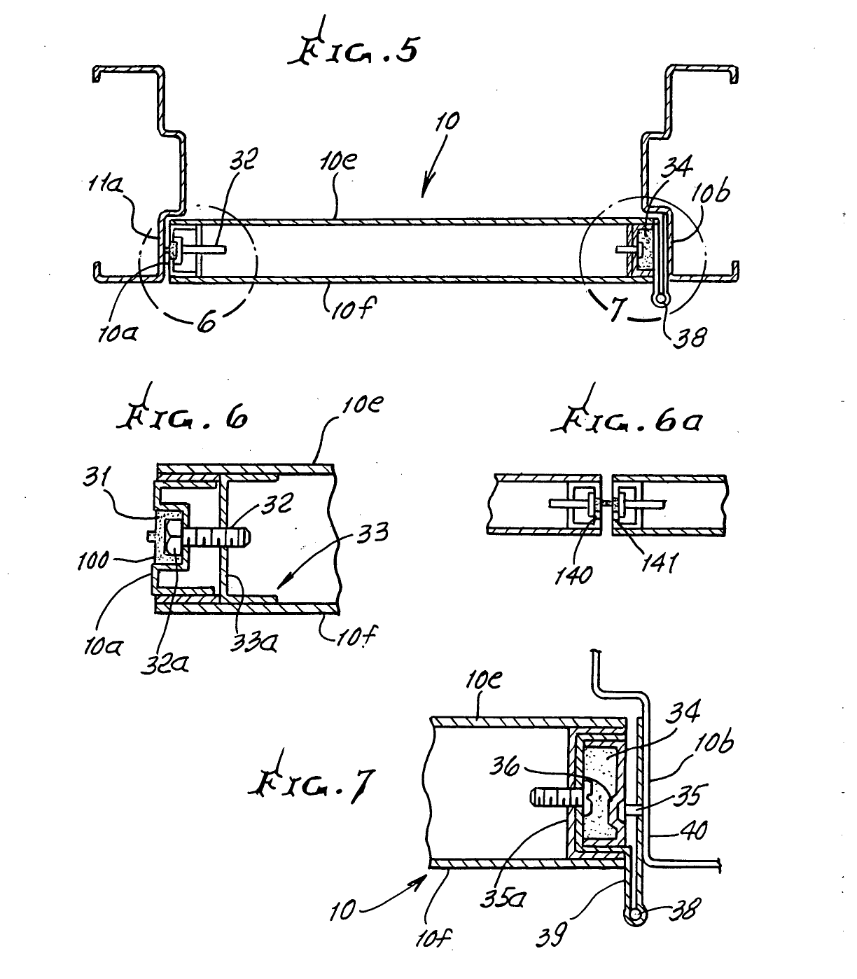

FIGS. 5 and 6 show adjustable door vertical edge 10a, with sealing material 100 carried by the door in a recess 31 at the edge. A threaded adjuster 32 engages a carrier 33 having a flanges 33a received between door panels 10e and 10f. The adjuster head 32a controllably engages the movable door vertical edge to adjust its position, toward or away from the frame (or opposing door) edge 11a, to adjust door sealing upon door closure. Typically, the seal wall is adjusted to contact the frame, in door closed position. Multiple adjustment locations spaced apart vertically, are indicated at 250, in FIG. 1, to seal the gap which may vary in width along door vertical edge. FIG. 6a schematically shows similar FIG. 6 structure, employed at opposed edges 140 and 141 of two movable doors, in face to face relation. See also the same or similar structure at FIG. 7, with seal 34 carried by the door proximate the frame edge 10b. A stop 35 carried at the frame has a head 35a engaging a wall 36 of the door edge to limit and control positioning of the seal 34. Door pivot at 38 controls pivoting of door edge panel 39 relative to doorway frame panel 40.

In the above, latch rods 16 and 17 and latches are held in latching position by cam positioning in the actuator train, until release, and when latch rods are in latch release position, gravitational force exertion on the mechanism holds the rods retracted against movement into distended latching position. This obviates need for springs to hold rods in position, and simplifies overall structure and operation.

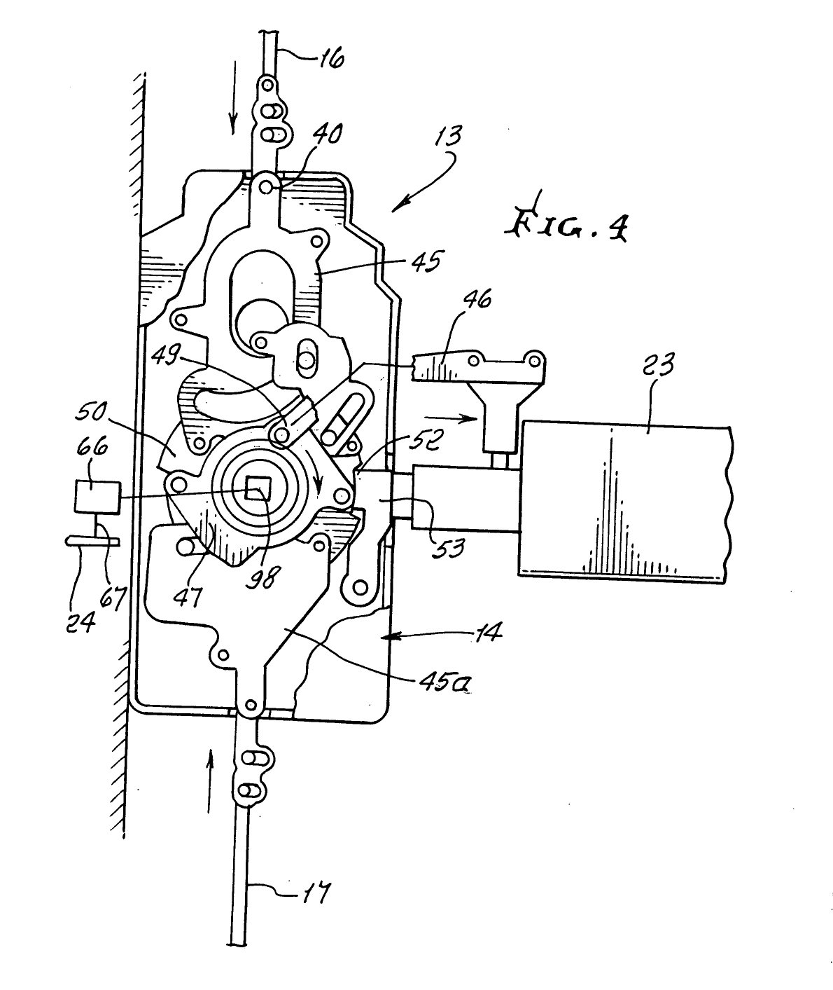

Referring now to FIG. 3 it shows the door latching apparatus 13 in door locked or latched position, and to FIG. 4 showing 13 in door unlatched position. It includes a receptacle 14 fitting in door recess 14a, and containing control elements operatively connected to the latch rods 16 and 17.

Actuator plate 45, connected at 40 to latch actuator rod 16, is displaced downwardly in response to rightward movement of link 46 caused by pushing of the push bar 23, as can be seen in FIG. 4. This occurs in response to clockwise pivoting movement of link 47 about axis 98. In this regard, link 46 is coupled at 49 to rotor 50 rotate it clockwise, to displace 47 to FIG. 4 position, causing 45 to be displaced downwardly, and plate 45a to be displaced upwardly.

If external rotor 24 is rotated manually, it likewise causes rotor 50 to rotate clockwise; however, the handle cannot rotate if the actuator coupled to 50, is blocked, as at location 52 in FIG. 4, by lever 53. Turning of the key 26 in slot 26a serves to unblock rotation of 51, by limited rightward rotation of lever 53.

If rotation of handle 24 is blocked and excess torque is applied, provision is made for disengagement of a coupler in the handle torque transmission path. This is shown, schematically, by coupler 66, in FIG. 4, coupled to handle 24 at 67, and to rotor 50.

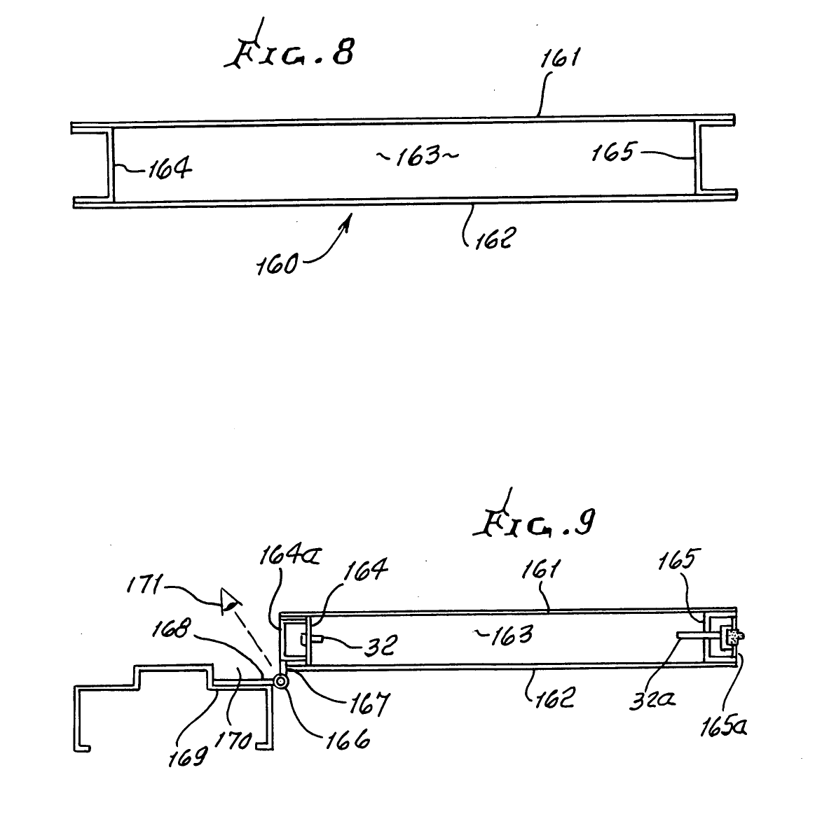

In FIG. 8, a modified door 160 has front and rear vertical panels 161 and 162, and door interior 163. Channel shaped receptacles 164 and 165, U-shaped in section, fit between the panels, and open oppositely endwise to receive sealing structure as shown in FIG. 6. FIG. 9 also shows the receptacles as well as adjustable door edge sealing elements 32 and 32a, and sealing walls 164a and 165a. The receptacles are box shaped as shown and move toward or away from frame edges as threaded adjusters 32 and 32a are rotatably adjusted. A hinge 166 has plate connection at 167 to receptacle 164 and at 168 to door frame 169. When the door is closed and receptacle 164 is closed into frame space 170, the hinge is concealed from eye view 171.

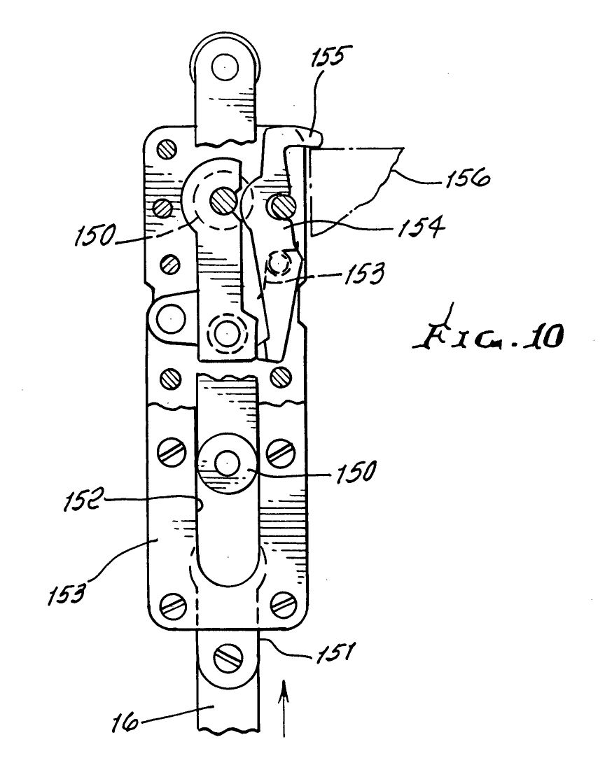

In FIG. 10, rollers or guides 150 are carried by latch plate 151 moved up and down by latch rod 16, in guide slot 152 in plate 152 attached to the door.

Spring 153 holds arm 154 in pivoted position, with protrusion 155 engaging frame 156, blocking release of downward travel of rod 16, until that rod is pulled downward.

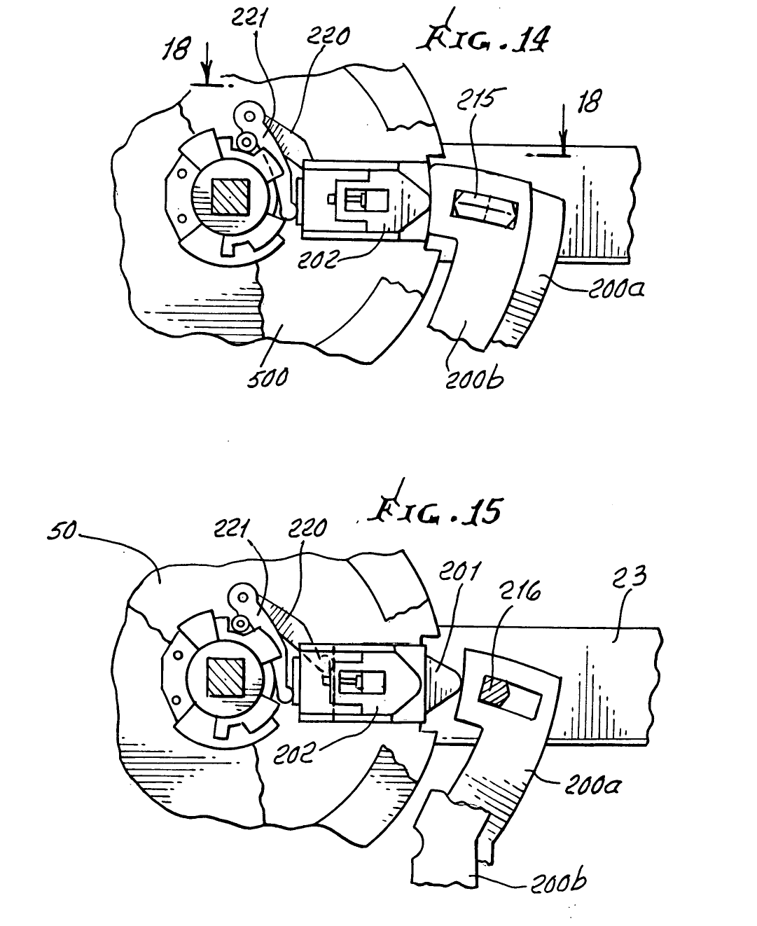

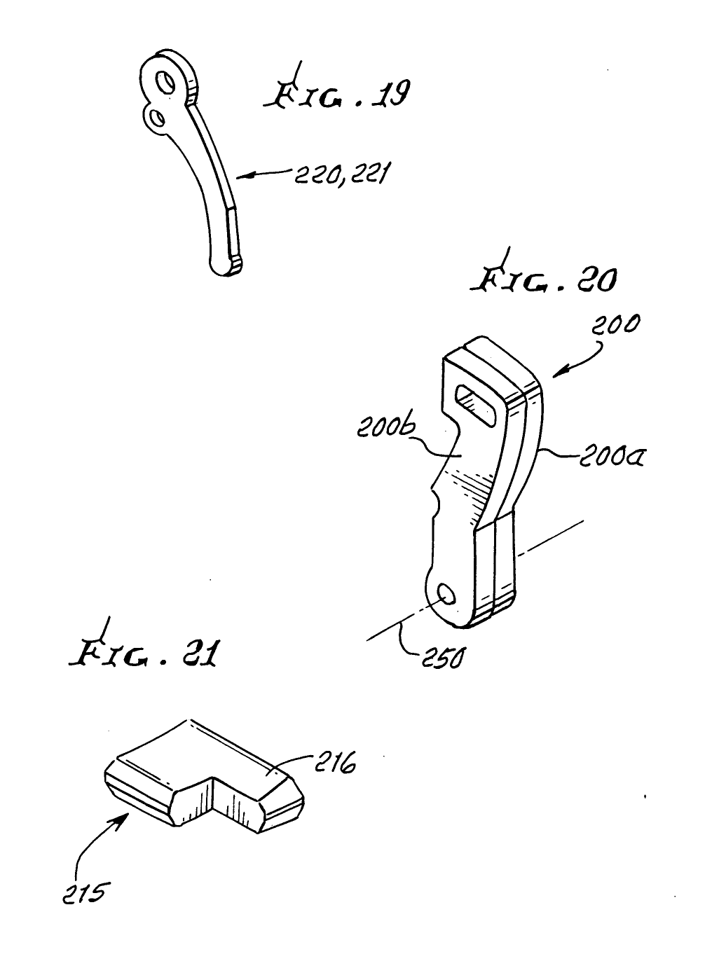

FIG. 11 is a view like FIGS. 3 and 4, but showing elements in greater detail. See also FIGS. 16-21. That assembly includes a lock bar 200 movable between door locking and unlocking positions, and first and second push bars 201 and 202 respectively to operate from door inside and outside handle positioning to control such lock bar movement. The lock bar 200 typically has two side-by-side sections 200a and 200b (see FIG. 20) pivoted at 250, and respectively pivotally movable by the push bars 201 and 202. See FIGS. 16-18.

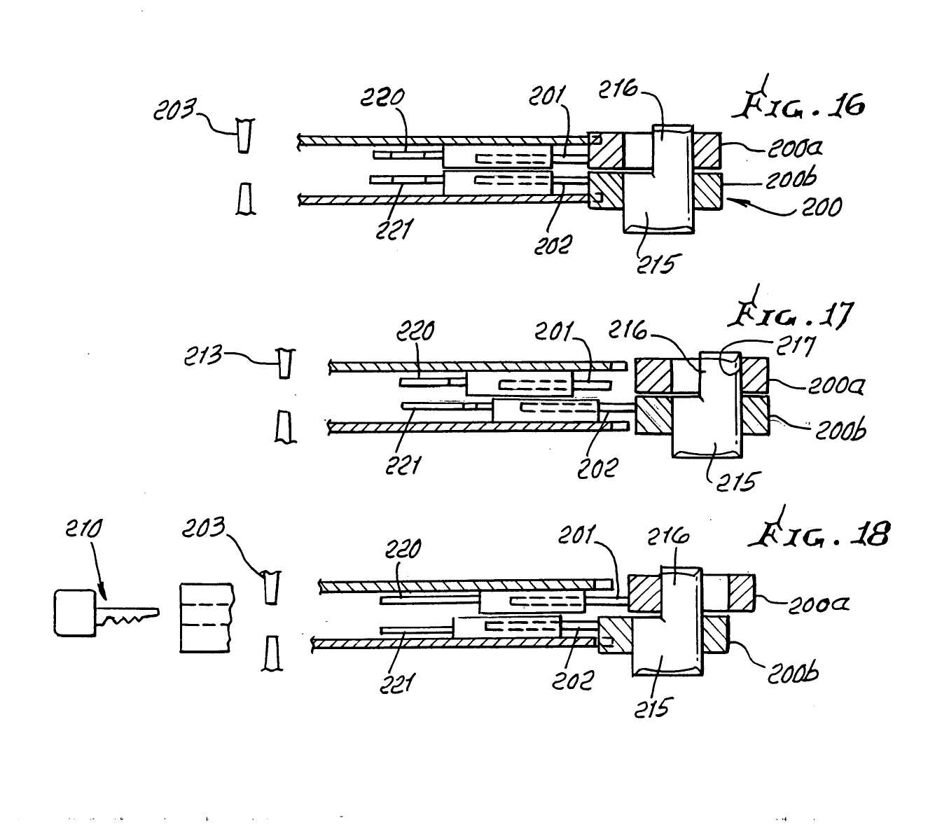

One lock bar section 200a is pivotally movable in response to outside door handle 203 movement at the outer side of the door, and with associated movement (to the right, in FIG. 18) of a first push bar 201, as when the door is key unlocked and openable. If the door remains locked by the key 210, push bar 202 remains in FIG. 16 position, and the party, at the outer side of the door is unable to open the door without a key. With a key, that person can effect rightward movement of the push bar 202, to displace lock bar section 200b to FIG. 17 position, enabling rotation of the rotor 50, and unlatching of the door.

The other lock bar section is movable to FIG. 17 rightward position in response to door handle movement at the inner side of the door, and with associated rightward movement of the second push bar 202. See FIG. 17. Lock bar section 200b is thereby carried to the right by a slider 215 having a leg 216 engaging wall 217 of lock bar section 200a. The lock bar sections shown in FIG. 17 do not then block rotation of rotor 50, enabling door unlatching. Slider 215 is slidable in the opening 217 in bar section 200a, as between positions shown in FIGS. 17 and 18. Slider 215 is also referred to as a coupler, herein. Accordingly, the invention extends to provision of a slidable coupler received in an opening formed by said lock bar sections, one opening in one section sized to block coupler movement relative to said one lock bar section whereby the door remains latched, and a second of said openings in the other lock bar section sized to allow coupler movement relative to said second lock bar section whereby the door becomes unlatched.

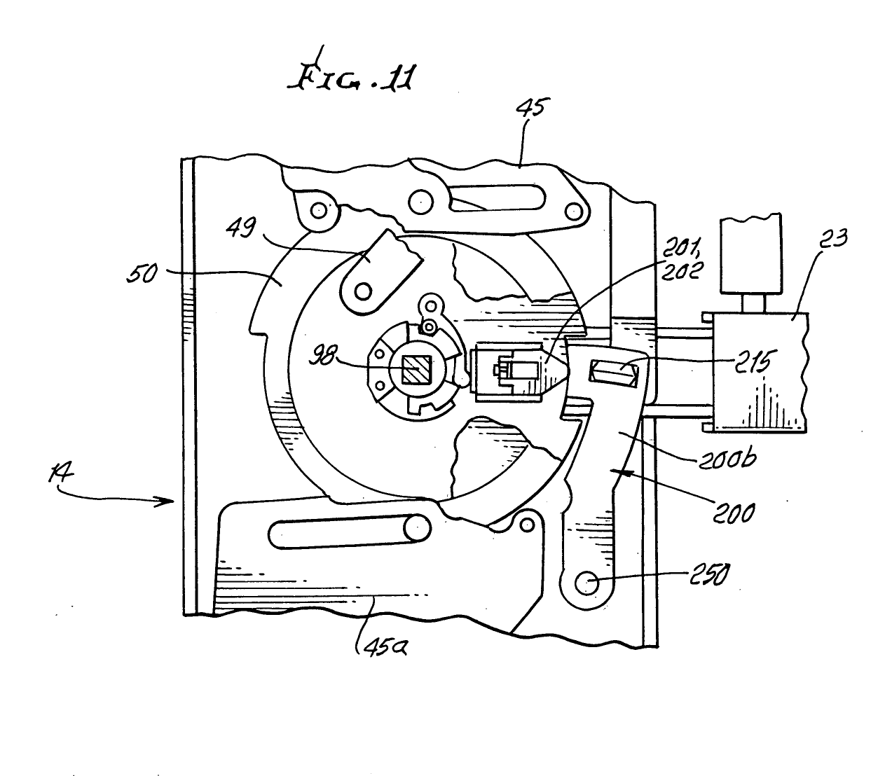

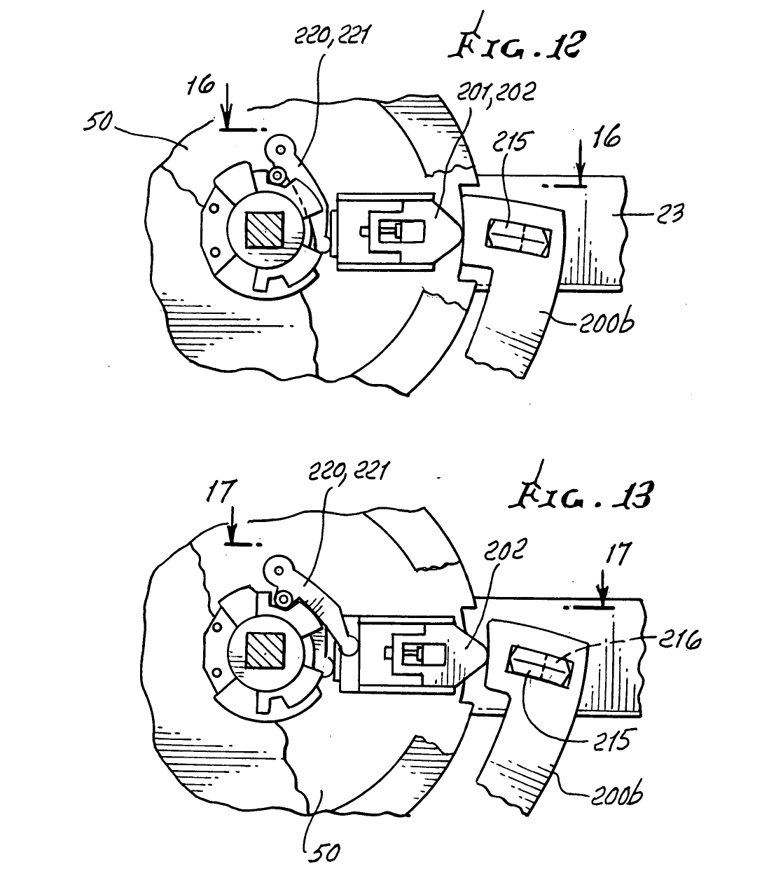

Push bar structure also appears in FIGS. 12-15. Push bar operating links are shown at 220 and 221.

We claim:

1. In a lockable door system, the combination comprising
a) a door locking first assembly installable in a door for control of operable use to lock or unlock the door,
b) friction limiting upper latch assembly including a locking plunger, and means to guide plunger travel upwardly at door top level into locking and unlocking position, there being means guiding said travel,
c) said first assembly including a rotor rotatable by handle or push bar to control door locking and unlocking, and means connecting said rotor with said plunger.

2. The combination of claim 1 including a key operated means for controlling said rotor rotation.

3. The combination of claim 1 including a clutch operatively connected with said rotor to initially resist rotor rotation and subsequently to allow rotor rotation after pre-determined torque application to the rotor, as from the door handle at the outer side of the door.

4. The combination of claim 3 wherein the door has external and internal manually operable controls, the clutch operatively connected with one of said controls.

5. The combination of claim 4 wherein said one control is an external handle.

6. The combination of claim 4 wherein the clutch includes means sized to determine the level of said pre-determined torque application.

7. The combination of claim 6 wherein the clutch includes an element located to disconnect the handle from the rotor, at said pre-determined torque application level.

8. The combination of claim 1 include door edge sealing means which is adjustable, to seal off a) against the door frame, and/or at the meeting point of two opposing doors in a pair, in closed position of the door.

9. The combination of claim 8 wherein the sealing means include an integrated sealing surface located to have substantial contact with the door frame, or opposing door, in said door closed position.

10. The combination of claim 1 wherein said means includes rotary cam structure configured to progressively urge said plunger upwardly in response to handle turning, operating to rotate said rotor.

11. Door locking and unlocking apparatus comprising
a) a lock actuator assembly sized to fit inside a door, and operatively connected to a latch at a door upper edge,
b) a push bar carried by the door at the door inside and operatively connected to the lock actuator assembly to control unlatching of the latch,
c) a handle carried by the door at the door outside, and operatively connected to the lock actuator assembly, to control unlatching of the door only after positioning of a key to effect unblocking of the actuator assembly.

12. The apparatus of claim 11 wherein the actuator assembly includes a first part bodily movable in response to push bar displacement to transmit actuation to a vertically movable latch actuator.

13. The apparatus of claim 11 wherein the actuator assembly includes a rotor operatively connected to the handle and to said first part.

14. The apparatus of claim 11 including a rotor rotatable to transmit actuation to said latch actuator, in response to displacement of said handle, there being means blocking rotor rotation until key turning to unblock said blocking means.

15. The apparatus of claim 11 including a door having an interior space opening only toward a vertical edge of the door, said actuator assembly received in and concealed in said space, said door being free of latching at said door vertical edge.

16. The apparatus of claim 11 including adjustable sealing means at the door edge, for controlling sealing to a door frame in door closed position.

17. The apparatus of claim 11 including a clutch limiting turning of the handle in response to failure or absence of key turning.

18. The apparatus of claim 17 wherein the clutch disengages to provide said limiting.

19. In a lockable door assembly, the improvement comprising
a) the door having parallel upright elongated channels at opposite upright door edges,
b) the door having at least one of the following:
i) adjustable means in one of the channels for sealing with a door frame edge lengthwise of the one channel,
ii) adjustable means in both of the channels for sealing with door frame edges lengthwise of both of the channels.

20. The improvement of claim 19 including a concealed door hinge associated with said sealing means.

21. The improvement of claim 19 wherein at least one of said sealing means includes a receptacle fitting into at least one of the channels, and sealant in the receptacle.

22. The improvement of claim 21 including a door frame edge toward which the receptacle pivots about a concealed hinge axis as the door pivots above said axis, and including said hinge.

23. The improvement of claim 19 including a second door having an upright elongated channel and sealing means in the second door channel facing said channel on the first said door, with the two doors then extending in edge to edge closed position.

24. The improvement of claim 21 wherein said adjustable means include a pusher having adjusted position projecting into the sealant to pressurize the sealant.

25. The system of claim 1 wherein said locking plunger guide means includes roller means located to guide travel of the plunger into said locking and unlocking positions whereby force exerted on the door does not frictionally prevent said travel.

26. In a lockable door assembly, the improvement comprising:
a) an upwardly elongated channel at an upright door edge;
b) multiple adjustable means spaced apart in and along the channel,
c) each adjustable means configured for sealing positioning with one of the following:
i) a door frame edge facing said channel in door closed position,
ii) a second door edge facing said channel in door closed position

27. The combination of claim 1, wherein said assembly includes a lock bar movable between door locking and unlocking positions, and first and second push bars respectively to operate from door inside and outside handle positioning to control said lock bar movement.

28. The combination of claim 27 wherein said lock bar has two pivoted sections respectfully operable by said first and second push bars.

29. The combination of claim 28 including a slidable coupler received in an opening formed by said lock bar sections, one opening in one section sized to block coupler movement relative to said one lock bar section whereby the door remains latched, and a second of said openings in the other lock bar section sized to allow coupler movement relative to said second lock bar section, whereby the door becomes unlatched.

30. The combination of claim 29 wherein said one lock bar section is movable in response to door handle movement at the outer side of the door and with associated movement of a first push bar, when the door is key unlocked.

31. The combination of claim 30 wherein the other lock bar section is movable in response to door handle movement at the inner side of the door, and with associated movement of a second push bar, when the door is or is not key locked.

32. In a fire door system, tested and listed by a nationally recognized testing laboratory, the combination comprising door edge sealing means which is adjustable, to seal off a) against the door frame, and/or b) at the meeting point of two opposing doors in a pair, in closed position of the door.

33. The combination of claim 32 wherein said sealing means includes an integrated sealing surface located to have substantial contact with the door frame, or opposing door, in said door closed position.

34. The combination of claim 32 wherein said sealing is an integrated smoke seal.
